(19) United States
(12) Patent Application Publication
(10) Pub. No.: US 2003/0168609 A1
(43) Pub. Date: Sep. 11, 2003

(54) Indirectly heated button cathode for an ion source

(76) Inventors: Marvin Farley, Ipswich, MA (US); Takao Sakase, Rowley, MA (US); Shu Satoh, Byfield, MA (US); Geoffrey Ryding, Manchester, MA (US); Peter Rose, Rockport, MA (US)

Correspondence Address: APPLIED MATERIALS, INC., 2881 SCOTT BLVD. M/S 2061, SANTA CLARA, CA, 95050, US

(21) Appl. No.: 10/091,351

(22) Filed: Mar. 6, 2002

(51) Int. Cl. H01J 27/20

(52) U.S. Cl. 250/427

(57) ABSTRACT

An indirectly heated button cathode for use in the ion source of an ion implanter has a button member formed of a slug of tantalum mounted in a collar of tungsten. The lower thermionic work function of tantalum causes electron emission to be concentrated over the surface of a tantalum slug. The tantalum slug may be mounted to enable it to operate at a higher temperature compared to the surrounding tungsten collar portion. The resultant concentrated plasma in the ion source is effective to enhance the production of higher charge state ions, particularly P⁺⁺⁺ for subsequent acceleration for high energy implantation.

### FIELD OF THE INVENTION

This invention relates to an indirectly heated button cathode for an ion source, in particular for use in an ion implanter for implanting ions into target substrates such as semiconductor wafers.

### BACKGROUND OF THE INVENTION

It is known to use indirectly heated cathodes in the arc chambers of ion sources. In such arrangements, the cathode is formed as a button having a front thermionic electron emitting surface and a rear surface. The button is typically heated by the electron impact on the rear surface, by electrons emitted and accelerated from a filament located behind the rear surface of the cathode button. With this construction, the filament is protected from sputtering by energetic particles in the arc plasma formed in the arc chamber of the ion source. The heated cathode button emits thermionic electrons at its front surface, due to the arc potential in the arc chamber, to initiate and maintain the required arc. The cathode button can be made relatively thick and substantial, by comparison to directly heated filament cathodes, to give the cathode longer life in operation.

An indirectly heated button cathode for an ion source is disclosed in U.S. Pat. No. 5,497,006.

Certain processes in the manufacture of semiconductor devices require the implantation of atomic species at relatively high energies, so that the species are implanted at greater depths in the semiconductor substrate. High energy ion implanters are disclosed in U.S. Pat. No. 4,667,111 and in EP-A-1056113. These prior art high energy implanters use rf linear accelerators to accelerate the ions to the high energies required for implantation. Other forms of high energy accelerators are also known for use in ion implanters, including radio frequency quadrupole (RFQ) accelerators and tandetron accelerators. Such devices have been used to produce singly charged ions of species desired for implantation at energies up to between 500 KeV and 2 MeV. Fixed voltage electrostatic accelerators are also known which can provide singly charged ions at energies in excess of 200 KeV. However, for higher energies it is known to use ions of the desired species at higher charge states, typically doubly or triply charged. The energy delivered to a charged particle by an electric field is directly proportional to the number of charges on the particle.

The operation of ion sources can be optimised to enhance the production of ions at higher charge states. However this usually involves operating the ion source with a more intense arc, so that the life of consumable elements within the ion source, particularly the cathode, is reduced. A compromise is usually made between cathode life and the beam current at the desired higher charge state.

Attempts have been made to improve the performance of ion sources in order to maximise cathode life, while operating the cathode to generate relatively high currents of desired multiply charged species. For example, “ELS2: Extended Life Source With Dual Cathode”, I. Jonoshita et al, Ion Implantation Technology—98 pp.239-241, describes a scheme using a second button cathode in the arc chamber of an ion source to replace the usual electron reflector. A modest increase in life time is demonstrated.

### SUMMARY OF THE INVENTION

It is an object of the present invention to provide an improved cathode structure for the ion source of an ion implanter to enable the ion source to be optimised for the production of multiple charge state ions with a satisfactory cathode life time.

Accordingly, the invention provides an indirectly heated button cathode for an ion source, comprising a button member having a front face for emitting thermionic electrons, when in use, to form a plasma, said face for emitting having a central portion provided by a first material having a first thermionic work function and a peripheral portion, around said central portion, provided by a second material having a second thermionic work function greater than said first work function.

Because the central portion of the electron emitting face of the button cathode has a lower work function than the peripheral portion, electron emission is concentrated, in use, from the central portion. The electron emission area of the cathode can therefore be reduced in size, resulting in a more concentrated plasma within the arc chamber. The more concentrated plasma tends to have a higher energy density resulting in more favourable production of ions at higher charge states. In a particular embodiment, a slug of tantalum is fitted in a collar of tungsten in order to form the button member of the cathode.

The slug of tantalum can be made thicker than the tungsten collar, so that the slug protrudes rearwards of the rear face of the button. As a result, the rear face of the tantalum slug receives the dominant part of the electron heating by the accelerated electrons from the filament located behind the cathode button member.

Also, the front face of the tantalum slug, forming the central portion of the thermionic electron emitting face of the button member, may be made concave. This produces a slight focus of the primary electrons emitted from the front face, so as further to increase the energy density of the plasma.

The modified button cathode can be used to replace prior art button cathodes, typically having a solid tungsten button member, with minimum additional modification of the ion source.

### BRIEF DESCRIPTION OF THE DRAWINGS

An example of the invention will now be described with reference to the accompanying drawings in which:

FIG. 1 is a cross-sectional view of the arc chamber of an ion source for use in an ion implanter and including a modified button cathode embodying the present invention;

FIG. 2 is a front view of the modified button cathode embodying the invention;

FIG. 3 is a cross-sectional view of the button cathode, taken along line A-A of FIG. 2; and

FIG. 4 is a perspective view of the button cathode.

### DETAILED DESCRIPTION OF THE PREFERRED EMBODIMENT

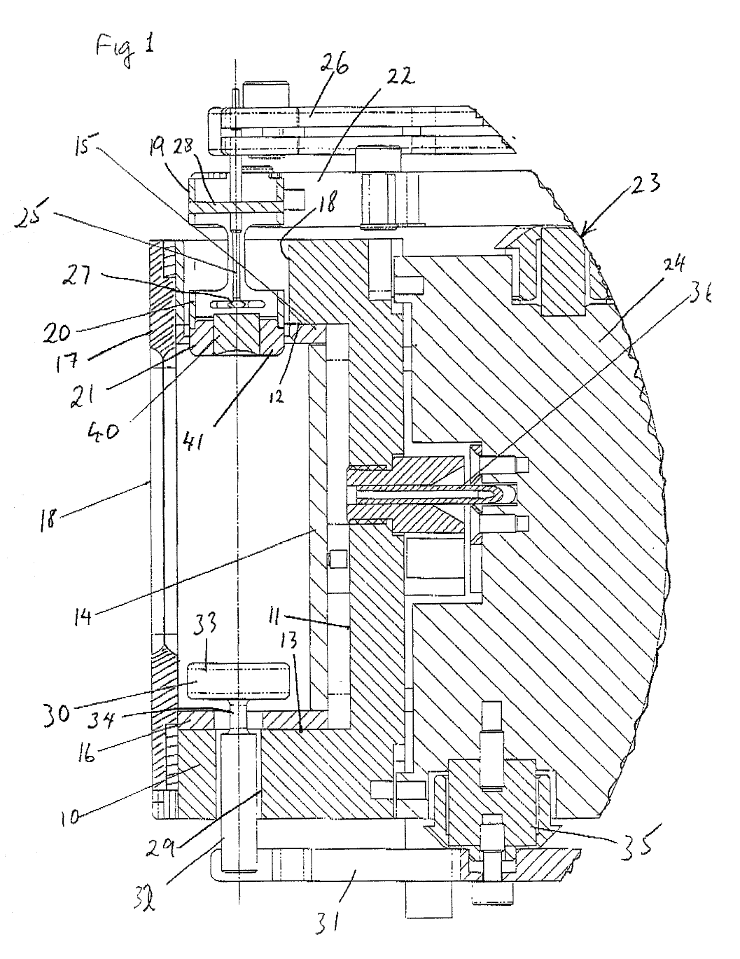

In the description and claims that follow, relative terms such as upper and lower, rear and front have been used for simplicity of description. Upper and lower have been used only with reference to the orientation of the example illustrated in FIG. 1 of the drawings, and, in an actual installation of the embodiment, any orientation relative to vertical is feasible. Rear and front have been used such that the distinction should be apparent from the context. For example, the terms are used with reference to the arc chamber in accordance with the convention that the ion beam is emitted from the front. Similarly, the term front is used with reference to the face of the button member of the cathode to denote the face which is directed away from the neighbouring arc chamber wall and into the interior of the arc chamber.

In FIG. 1, the arc chamber of an ion source comprises an arc chamber body 10 having a rear wall 11 and upper and lower end walls 12 and 13. The rear wall 11 and upper and lower end walls 12 and 13 are protected by graphite liners 14, 15 and 16. The arc chamber has a front plate 17 which provides a slit opening 18 through which ions formed in the arc chamber can be extracted to provide the required ion beam.

The upper end wall 12 of the arc chamber body 10 has an aperture 18 in which is mounted a cathode structure 19. The cathode structure 19 comprises a cylindrical body 20 bearing a button member 21 at its lower end. The cylindrical body is clamped in position by clamping members 22 which are in turn secured on electrically insulating mounts 23 to an ion source part 24 at the rear of the arc chamber body 10. The clamping members 22 hold the cylindrical body 20 of the cathode structure in spaced relation to the aperture 18 through the upper end wall 12 of the arc chamber body, and a corresponding aperture through the graphite liner 15, with the button member 21 penetrating a short distance into the interior of the arc chamber.

A tungsten filament 25 is also clamped by additional clamping members 26 so that filament element 27 is positioned a short distance to the rear of button member 21 within the cylindrical cathode body 20.

In the described embodiment, a bar 28 is secured across the outer end of the cylindrical cathode body 20, and one connecting lead to the filament element 27 extends on each side of the bar 28 out through the upper open end of the cylindrical cathode body 20 to be secured in the clamping member 26.

The lower end wall 13 of the arc chamber body 10 has an aperture 29 communicating with the inside of the arc chamber through a corresponding aperture in the graphite liner 16. An anti-cathode or electron reflector 30 is mounted by means of a clamping arrangement 31 so as to extend through the aperture 29. The electron reflector 30 is formed with a shaft portion 32 having an outer end held in the clamp 31, extending in spaced relationship with the interior wall surface of the aperture 29. The shaft portion 32 is connected to a head portion 33 by means of a neck portion 34. The head portion 33 is circular about the axis of the shaft portion 32 and has a diameter substantially the same as or slightly greater than the diameter of the button member 21 of the cathode structure 19, and an axial thickness of about 6 mm. The clamping arrangement 31 supporting the electron reflector 30 is itself mounted by an insulating mount 35 on the ion source part 24.

A feed tube 36 is fitted through the rear wall 11 of the arc chamber body 10, in order to provide a feed of a desired process gas to the arc chamber for generating desired ions for implantation.

The ion source arc chamber described above and illustrated in FIG. 1 is of the Bernas type and as will be known to the skilled person, a magnetic field extending axially between the cathode and the electron reflector is provided by magnet arrangements which are not shown in FIG. 1.

In operation, a filament current from a filament supply (not shown) flows through the tungsten filament 27. The filament 27 is also biased negatively relative to the cathode structure 19. Thermionic electrons emitted by the filament 27 are thus accelerated to impact the rear face of the cathode button member 21, in order to heat the button member to a required thermionic electron emission temperature. The cathode structure 19, including the button member 21, is itself negatively biased by an arc supply, so as to provide an arc potential between the button member 21 and the body 10 of the arc chamber. Thermionic electrons emitted from the front (lower) face of the button member 21 are confined by the magnetic field to travel substantially axially between the cathode button member 21 and the head 33 of the electron reflector 32. The electron reflector 32 is typically also biased relative to the cathode body 10, at the same potential as the cathode structure 19.

The energetic primary thermionic electrons from the cathode button member 21 ionise molecules of the process gas fed into the arc chamber by the feed tube 36, to produce a plasma in the arc chamber in the space between the cathode button member 21 and the head 33 of the electron reflector. As is known to those skilled in this art, the process feed gas is selected to include atoms of the species to be implanted and the plasma within the arc chamber may produce ions of various molecular and atomic species resulting from dissociation of the feed gas molecules. Furthermore, it is known that the gaseous species in the plasma in the arc chamber may be ionised to different charge states. Higher charge states are typically generated as a result of increased energy density within the plasma.

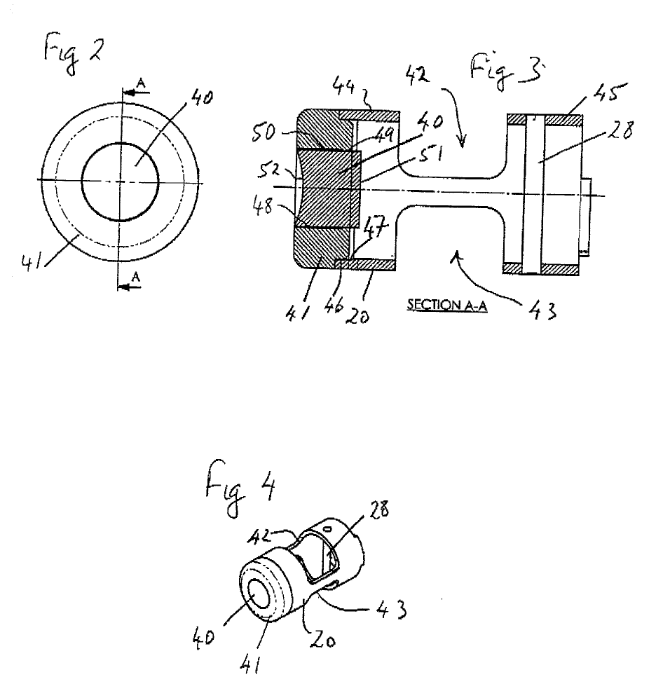

As can be seen in FIG. 1, the button member 21 of the cathode structure 19 comprises a central stud or slug 40 fitted in an outer collar 41. This structure will be described in greater detail with reference to FIGS. 2 to 4. The cathode structure comprises a cylindrical body 20 which is typically made of tungsten. The body 20 has opposed cutouts 42 and 43, essentially dividing the cylindrical body into an inner end 44 carrying the collar 41 of the button member 21, and an outer end 45 by which the cathode structure is secured by the clamping arrangement 22 as shown in FIG. 1. The collar 41 of the button member is formed with an external annular rebate 46 which forms a press fit with a slightly rebated inside edge 47 of the inner end 44 of the cathode body 20. In assembly, the collar 41 is also formed of tungsten and is press fitted to engage with the inner end of the cathode body 20. The two parts are then electron beam welded together.

The collar 41 carries the cylindrical slug 40 of the cathode button member. The slug 40 in this example is made of tantalum. The tantalum slug 40 is fitted in a cylindrical bore 48 in the collar 41. The bore 48 has an inner end 49 which has a diameter slightly less than the diameter of the major part 50 of the rest of the bore 48. The difference in diameter may be as small as about 0.2 mm. The outer diameter of the slug 40 may be substantially the same as the diameter of the larger portion 50 of the bore 48. On assembling the parts, the slug 40 is shrink fitted into the bore 48, by cooling the slug 40 in liquid nitrogen. Because the primary connection between the slug 40 and the collar 41 is only at the inner end 49 of the bore 48, the thermal conductivity between the slug 40 and the collar 41 is reduced.

As can be seen in FIG. 3, the slug 40 has a rear face 51 protruding rearwardly by a short distance, typically about 1 mm, beyond the rear face of the collar 41. Also, the front face 52 of the slug 40 is formed to be spherically concave. In one example, the slug may have a length of about 7 mm and a diameter of about 8 mm and the radius of curvature of the concave front surface 52 of the slug may be about 10 mm. In this example, the outer diameter of the collar 41 may be about 16 mm and the axial thickness may be about 6 mm.

The indirectly heated button cathode described above and illustrated in the drawings has a number of advantages over prior art cathodes.

Tantalum has a lower thermionic work function (4.25 eV) than tungsten (4.55 eV). As a result, when the button member comprising the tantalum slug 40 and tungsten collar 41 is heated, electrons are thermionically emitted preferentially from the front face 52 of the tantalum slug 40. In operation within the ion source as illustrated in FIG. 1, this can result in the plasma produced in the arc chamber being more concentrated along the axis of the chamber. Although tungsten and tantalum are used respectively for the collar portion 41 and slug 40 in the described example, other materials having appropriate work functions may be employed. For example the collar could be made of Rhenium (work function 4.96 eV), in combination with a slug of Ta or W.

Because the tantalum slug portion 40 protrudes rearwardly relative to the tungsten collar 41 as shown in FIG. 3, the electric field between the filament 27 (FIG. 1) inside the cathode body 20, and the rear of the button member 21, is enhanced over the rear face 51 of the slug 40. As a result, heating of the button member by the electron flux from the filament 27 is concentrated over the rear face of the slug, so that the temperature of the front face 52 of the slug can be higher than the temperature of the surrounding collar 41.

Because of the method of securing the slug 40 within the collar 41, thermal conduction from the slug 40 to the collar 41 is also reduced, again enhancing the temperature of the slug and thermionic emission from the front face 52.

The concave shape of the front face 52 of the slug 40 tends to concentrate thermionically emitted electrons towards the axis of the arc chamber.

All these features identified above serve to enhance the concentration of plasma generated in the arc chamber, enabling an increased plasma density, whilst maintaining a satisfactory cathode life time. This permits the arc chamber to be operated to optimise the production of ion species at higher charge states. In particular the ion source can be optimised for the production of triply charged phosphorus ions.

For an arc voltage of 120 Volts and an arc current of 2.0 Amps, the lifetime of the cathode embodying the invention and described above is more than 50 hours when continuously running a P⁺⁺⁺ beam of 1 mA. By comparison a prior art tungsten cathode under the same arc voltage and arc current provides a P⁺⁺⁺ beam current of only 0.5 mA and burns out in just 16 hours.

A contributing factor to the improved performance enabling the source to produce a higher P⁺⁺⁺ beam current is that the Ta slug cathode produces less spurious arcing during operation, than a W cathode. This is believed to be because the Ta slug is operating near its melting point (about 2850° C.), and therefore recrystallises quickly, eliminating small grain structure. By comparison, W has a melting point of about 3300° C. and, at the operating temperature, recrystallises more slowly, maintaining a small grain structure for longer. As the W cathode is sputtered, the small grains can become dislodged and cause a spurious arc discharge.

In prior art Bernas ion sources using an indirectly heated button cathode, the counter cathode or electron reflector is usually made of tungsten. In the embodiment of the present invention as illustrated in FIG. 1, the counter cathode 30 is also made of tantalum. This contributes to the improved performance by reducing spurious arcing as outlined above.

The cathode structure described above is one example of the invention. In another example, the central portion of the button member, while having a lower thermionic work function than the collar portion, may have a flat electron emitting face and may have the same axial thickness as the collar portion. In a further example, the slug portion and the collar portion may both be made of the same material, e.g. tungsten or tantalum, and the slug portion is arranged to protrude rearwardly relative to the collar portion. In this example, the front face of the slug portion may be flat or concave. In a still further example, the button member may be made as a single disc of tungsten or tantalum with at least a central part of the front electron emitting face formed to be concave.

Other arrangements are also within the scope of the invention as defined by the following claims.

What is claimed is:

1. An indirectly heated button cathode for an ion source, comprising a button member having a front face for emitting thermionic electrons, when in use, to form a plasma, said face for emitting having a central portion provided by a first material having a first thermionic work function and a peripheral portion, around said central portion, provided by a second material having a second thermionic work function greater than said first work function.

2. An indirectly heated button cathode as claimed in claim 1, wherein said central portion is circular and said second portion is annular.

3. An indirectly heated button cathode as claimed in claim 1, wherein said button member comprises a collar of said second material and a slug of said first material secured in said collar.

4. An indirectly heated button cathode as claimed in claim 3, wherein said button member has a rear face opposite to said front face, for exposure to electron heating in use, and said slug protrudes rearwards relative to said collar.

5. An indirectly heated button cathode as claimed in 1, wherein at least part of said face for emitting is concave.

6. An indirectly heated button cathode as claimed in claim 5, wherein said central portion of said face for emitting is concave.

7. An indirectly heated button cathode as claimed in claim 1, wherein said second material is tungsten.

8. An indirectly heated button cathode as claimed in either claim 1 or claim 7, wherein said first material is tantalum.

9. An indirectly heated cathode for an ion source comprising a button member having a front face for emitting thermionic electrons, when in use, to form a plasma, at least part of said face for emitting being concave.

10. An indirectly heated cathode for an ion source as claimed in claim 9, wherein said front face is circular having a concentric central portion and an annular outer portion, wherein only said central portion is concave.

11. An indirectly heated cathode for an ion source comprising a button member having a front face for emitting thermionic electrons, when in use, to form a plasma, said button member having a rear face opposite to said front face for exposure to electron heating in use, said rear face having a central portion and an exposed surrounding portion, said central portion protruding rearwardly relative to said surrounding portion.

12. An indirectly heated cathode as claimed in claim 11, wherein said button member comprises a collar piece and a slug piece secured in said collar piece said slug piece protruding rearwardly to form said central portion of said rear face.

13. An indirectly heated cathode as claimed in claim 12, wherein said slug piece provides a central portion of said front face of the button member and said collar piece provides a peripheral portion of said front surface surrounding said central portion, said slug piece being secured in said collar piece so as to provide a temperature difference between said slug piece and said collar piece when said central portion of said rear face of the button member is exposed to electron heating.

14. A method of creating a plasma for use in ion implantation comprising
providing an arc chamber with an indirectly heated button cathode having a button member with a front face for emitting thermionic electrons into said arc chamber for acceleration therein to form a plasma,
forming a central portion of said face for emitting with a first material having a first thermionic work function,
forming a peripheral portion of said face, around said central portion, with a second material having a second thermionic work function greater than said first work function,
accelerating electrons, thermionically emitted by a filament onto a rear face of said button member opposite to said front face, to heat said button member to cause thermionic emission of electrons from at least said central portion of said front face of the button member,
and electrically biasing said cathode to accelerate said thermionically emitted electrons from said front face of said button member to ionise gas molecules in said arc chamber to produce a plasma therein.

15. A method of creating a plasma for use in ion implantation comprising
providing an arc chamber with an indirectly heated button cathode having a button member with a front face for emitting thermionic electrons into said arc chamber for acceleration therein to form a plasma,
forming at least part of said face for emitting to be concave,
accelerating electrons, thermionically emitted by a filament onto a rear face of said button member opposite to said front face, to heat said button member to cause thermionic emission of electrons from at least said concave part of said front face of said button member,
and electrically biasing said cathode to accelerate said thermionically emitted electrons from said front face of said button member to ionise gas molecules in said arc chamber to produce a plasma therein.

16. A method of creating a plasma for use in ion implantation comprising
providing an arc chamber with an indirectly heated button cathode having a button member with a front face for emitting thermionic electrons into said arc chamber for acceleration therein to form a plasma,
forming a rear face of said button member, opposite to said front face, with a central portion of said rear face protruding rearwardly relative to an exposed surrounding portion of said rear face,
accelerating electrons, thermionically emitted by a filament, onto said protruding central portion of said rear face of said button member, to heat said button member to cause thermionic emission of electrons from at least a central portion of said front face of the button member corresponding to said central portion of said rear face,
and electrically biasing said cathode to accelerate said thermionically emitted electrons from said front face of said button member to ionise gas molecules in said arc chamber to produce a plasma therein.

17. An ion source comprising an arc chamber having first and second opposed walls,
an indirectly heated button cathode located in said first wall, and
an electron reflector located in said second wall, said button cathode having a disc-shaped button member with a generally circular front face for emitting thermionic electrons, when in use, to form a plasma in said arc chamber, said front face for emitting having a central portion provided by a first material having a first thermionic work function and a peripheral portion, around said central portion, provided by a second material having a second thermionic work function greater than said first work function, said electron reflector having a disc-shaped head member providing a generally circular reflecting face formed of said first material directed towards said front face of said button member,
the ion source further comprising
a magnet to provide a magnetic field in said arc chamber aligned between said front face of said button member and said reflecting face of said head member to confine electrons to a column extending in said arc chamber between said cathode and said electron reflector.

18. An ion source as claimed in claim 17, wherein said first material is tantalum and said second material is tungsten.
